(19) United States
(12) Patent Application Publication
(10) Pub. No.: US 2026/0125529 A1
(43) Pub. Date: May 7, 2026

(54) Multi-Stage Processing of Sealant Materials

(71) Applicant: Zephyros, Inc., Romeo, MI (US)

(72) Inventors: Michael Czaplicki, Romeo, MI (US); Christopher Hable, Romeo, MI (US); Jeff Apfel, Romeo, MI (US)

(21) Appl. No.: 18/706,259

(22) PCT Filed: Nov. 3, 2022
(86) PCT No.: PCT/US2022/048810

§ 371 Date: Apr. 30, 2024

Related U.S. Application Data
(60) Provisional application No. 63/275,164, filed on Nov. 3, 2021.

(51) Int. Cl. C08J 9/00; B62D 65/00; C08J 9/10; C08L 23/06; C09K 3/10

(52) U.S. Cl. CPC C08J 9/0061; B62D 65/00; C08J 9/103; C08L 23/06; C09K 3/10; C08J 2203/04; C08J 2323/06; C08J 2423/08; C08J 2423/16; C08J 2423/20; C08L 2203/14; C08L 2205/025; C08L 2205/035; C08L 2205/06; C08L 2207/062; C08L 2207/066; C08L 2207/20; C09K 2200/062; C09K 2200/0622; C09K 2200/0642

(57) ABSTRACT

The present teachings generally relate to a sealant composition that is adapted to be foamed, cured or some combination thereof, a method of making the activatable sealant composition and methods of using the same. The activatable sealant composition comprises one or more preferably high softening point or high melting point polymeric materials; one or more foaming agents; one or more foaming agent activators; and one or more hydrocarbon resins; wherein the activatable sealant composition is supplied to an article of manufacture for providing functional attributes such as scaling, baffling, dampening, reinforcement, or a combination thereof.

### FIELD

The present teachings generally relate to a multi-step processing method and composition types for activatable sealing materials that would otherwise be activated by heat during compounding using a single step process.

### BACKGROUND

For many years the automotive industry has been concerned with the sealing of vehicles from noise, fuel fumes, and harsh weather conditions such as rain, snow, excess heat, and humidity. Proper sealing can isolate the cabin of the vehicle from exterior noise, protect the interior components such as electronics from moisture and salt, as well as prevent corrosion of components located within vehicle panel cavities and aid in the overall comfort of the vehicle. Among the sealing strategies employed by the automotive industry is the use of heat-activated foamable or non-foamable pre-formed sealants that may be cross-linkable. These sealants are activated during one or more of the processing steps used to cure the various layers of paint during coating the vehicle. Thus, the heat reactive sealant must develop adhesion and foam, if necessary, at similar times and temperatures to the paint coatings that are utilized. These times and temperatures are typically in the range of about 20 to 40 minutes and about 150 to 200° C., respectively. Therefore, to avoid premature activation (e.g., foaming and/or crosslinking) of the sealant material, compounding and formation of the sealant must typically occur well below these temperature ranges.

The present teachings provide for multi-stage processing methods that allow for a broad selection of polymeric materials that may have higher initial compounding temperatures, and therefore would not be traditionally used for these types of activatable sealants. This may include polymeric materials that are lower in cost, more readily available from a wider supply base and from more diversified sources. In some cases, the polymeric materials may have mechanical and physical properties that are difficult to obtain when using traditional ingredients. Furthermore, processing of sealant materials according to the present teachings may make possible the use of polymeric materials readily available from recycled post-industrial or post-consumer sources.

In view of the above, it would be desirable to a provide a method of forming a foamable/curable sealant composition utilizing a multi-step processing method. It would be desirable to provide an foamable/curable sealant composition that uses polymeric materials not traditionally utilized in the field, enabling the selection of polymeric materials from a wider supply base and more diversified sources. Furthermore, it would be desirable to provide an foamable/curable sealant composition that is cheaper in cost and environmentally friendly (e.g., from the utilization of recycled materials).

### SUMMARY

The present teachings relate generally to an foamable/curable sealant, which may address one or more of the above needs, the foamable/curable sealant composition comprising: one or more preferably high softening point or high melting point polymeric materials; one or more foaming agents: one or more foaming agent activators; and one or more temperature processing aids; wherein the foamable/curable sealant composition is supplied to an article of manufacture for providing functional attributes such as sealing, baffling, dampening, reinforcement, or a combination thereof.

The foamable/curable sealant composition described herein may include one or more of the following aspects. The foamable/curable sealant composition may include one or more coagents, process oils, pigments, and/or inert fillers. The one or more preferably high softening point or high melting point polymeric materials may be from recycled post-industrial or post-consumer sources.

In one aspect, the teachings herein disclose an foamable/curable sealant composition comprising: one or more preferably high softening point or high melting point polymeric materials; one or more foaming agents: one or more foaming agent activators; and one or more temperature processing aids selected from hydrocarbon resins, process oils, waxes, EPDM, liquid elastomers, high melt flow copolymers or low melting point copolymers. The foamable/curable sealant composition is supplied to an article of manufacture.

The composition may include a coagent. The coagent may be selected from acrylates, methacrylates, or maleimides. The coagent may be any component having free radical reactivity.

The one or more preferably high softening point or high melting point polymeric materials may be selected from: high density polyethylene (HDPE), low density polyethylene (LDPE), or linear low density polyethylene (LLDPE). The one or more preferably high softening point or high melting point polymeric materials may be recycled from post-industrial or post-consumer sources. The one or more preferably high softening point or high melting point polymeric materials may comprise at least about 50% or more of the overall composition of the foamable/curable sealant.

The one or more foaming agents may be azodicarbonamide.

The one or more foaming agent activators may be selected from: zinc oxide, dicyandiamide, calcium salts, ureas, or substituted ureas.

The composition may include a process oil. The composition may include a pigment. The composition may include an inert filler. The composition may be heat-activated.

The composition may be supplied as a sheet, a strip, a patch, a ring, a disc, or combinations thereof to the article of manufacture. The article of manufacture may be a sealing baffle for an automotive vehicle.

In another aspect, the teachings herein are directed to a multi-step method for processing an foamable/curable sealant composition, the method comprising compounding one or more preferably high softening point or high melting point polymeric materials with one or more modifying ingredients in an initial step or steps to arrive at a resulting first mixture and compounding the resulting first mixture with one or more foamable/curable ingredients in a second or later step to arrive at an foamable/curable sealant composition. The second or later step may not be initiated until the temperature of the resulting first mixture is below a temperature at which the foamable/curable ingredients are activated.

The second or later step may occur at a lower temperature than the initial step or steps. The second or later step may be of a shorter duration than an initial step or steps.

The one or more preferably high softening point or high melting point polymeric materials may be selected from: high density polyethylene (HDPE), low density polyethylene (LDPE), or linear low density polyethylene (LLDPE). The one or more preferably high softening point or high melting point polymeric materials may be recycled from post-industrial or post-consumer sources. The modifying ingredients may be selected from one or more of the following: lower melting point polymeric materials (melting point preferably below 100° C.), lower softening point polymeric materials (softening point preferably below 100° C.), lower molecular weight polymeric materials (molecular weight preferably below 500 g/mol), waxes, hydrocarbon resins, plasticizers, process oils, or combinations thereof. The foamable/curable ingredients may be selected from one or more of the following: foaming agents, foaming agent activators, coagents, or combinations thereof.

The teachings herein are further directed to a sealant composition comprising one or more preferably high softening point or high melting point polymeric materials; one or more foaming agents: one or more foaming agent activators; and one or more ingredients selected from the following: hydrocarbon resins, process oils, waxes, EPDM, liquid elastomers, high melt flow copolymers or low melting point copolymers.

### BRIEF DESCRIPTION OF THE DRAWINGS

FIG. 1 shows a prior art material exposed to extreme humidity.

FIGS. 2A and 2B show a material in accordance with the present teachings.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

This application claims the benefit of the filing date of U.S. Provisional Application Ser. No. 63/275,164, filed Nov. 3, 2021, the contents of that application being fully incorporated by reference in its entirety for all purposes.

The present teachings provide for an foamable/curable sealant composition, a method of making the foamable/curable sealant composition and methods of using the same. The foamable/curable sealant composition of the present teachings can be employed to form parts for providing functional attributes such as sealing, baffling, dampening, reinforcement, or a combination thereof. The foamable/curable sealant composition may be useful to structures of articles of manufacture such as buildings, appliances, and/or transportation vehicles (e.g., boats, trains, automotive vehicles).

Activation of the sealant composition is typically caused by exposure to a stimulus, such as pressure, moisture, heat, radiation, or the like. Activation may result in the sealant composition undergoing a chemical and/or physical transformation. The transformation may include a change in shape such as flowing, foaming, expanding, and the like. The transformation may result in the creation of a physical barrier while developing adhesion to a substrate and/or sealing of a cavity. Preferably, the foamable/curable sealant composition activates upon exposure to heat. When the foamable/curable sealant composition is heat-activated, the heat for the activation may be supplied from a variety of sources such as, but not limited to, microwave energy, ionizing radiation, an oven, a thermoelectric device, electrical energy, chemical reaction, and/or combinations thereof and the like. In a preferred embodiment, the foamable/curable sealant composition is processed along with an article of manufacture and the natural processing or assembly steps employed to create the article will provide the heat. For example, the foamable/curable sealant composition may be applied to the structure of an automotive vehicle and may be activated upon exposure to temperatures frequently experienced in an e-coat oven bake, primer oven bake, paint oven bake, combinations thereof or the like for such automotive vehicles. Typical curing conditions encountered for automotive coatings range from about 150° C. or less, to about 200° C. or more, although there is a desire to reduce these temperatures.

The foamable/curable sealant composition may also undergo cross-linking. Cross-linking may aid in the capture of gases from foaming agents, aid in the adhesion of the sealant composition to surfaces it contacts, and/or increase the modulus of the sealant composition such that it better resists deformation or displacement from its designated location for the material to fulfill its sealing function.

### Composition

The foamable/curable sealant composition may include multiple different components or ingredients such as polymeric materials, copolymeric materials, foaming agents, foaming agent activators, coagents, resins, process oils, organic peroxides, antioxidants, pigments, fillers, and combinations thereof or the like. The multiple different components or ingredients may function to modify one or more physical properties of polymeric material(s) (e.g., melting point, softening point, viscosity) and/or aid in the activation of the sealant composition.

The foamable/curable sealant composition may include one or more polymeric materials. The one or more polymeric materials may be amorphous, crystalline, or a combination of both. Suitable amorphous polymeric materials include, but are not limited to, polystyrene, polymethylmethacrylate, and acrylonitrile butadiene styrene. Suitable crystalline polymeric materials for incorporation into the foamable/curable sealant composition include, but are not limited to, polypropylene, polyethylene terephthalate, polybutylene terephthalate, and polyethylene terephthalate glycol.

Preferably, the foamable/curable sealant composition may contain homopolymers, copolymers, and/or terpolymers of ethylene. By way of example, the foamable/curable sealant composition may contain high density polyethylenes (HDPE) (density 0.941-0.965 g/cm³), low density polyethylenes (LDPE) (density 0.91-0.925 g/cm³), copolymers of ethylene, and/or alpha olefins such as butene, hexene, and octene, which are also referred to as linear low density polyethylenes (LLDPE) (density 0.91-0.94 g/cm³). The Illustrative Examples of Tables 1-4 and Table 5 show suitable ethylene copolymers ranging from a melt flow rate (MFR) of about 7 g/10 min or less to about 70 g/10 min or higher. Unless expressly stated otherwise, MFR is determined in accordance with ISO 1133, at 190° C., 2.16 kg. For the purpose of the specification, melt flow rate (MFR) is used as a synonym to melt flow index (MFI).

The one or more polymeric materials included in the foamable/curable sealant composition may exhibit high softening points or high melting points. High softening point and high melting point materials are those which have softening and/or melting points of 100-120° C. Materials that soften or melt in this range require compounding or processing temperatures (e.g., 110 to 140° C. or more) which approach the temperatures experienced in a typical paint bake oven such that they would not typically be selected for use in materials that are intended to expand and/or cure in such ovens. Traditional processing of these high softening point and high melting point materials into a formulated foamable sealant would require elevated temperatures that could lead to premature activation and curing. Softening point of the polymers as described herein can be determined in accordance with ASTM-D1525.

The preferably high softening point or high melting point polymeric material(s) may comprise from about 30% or more, 40% or more, 50% or more, or even 60% or more by weight of the total amount of polymeric materials included in the foamable/curable sealant composition. Preferably, the preferably high softening point or high melting point high polymeric material(s) may comprise from about 30% or more, 40% or more, 50% or more, or even 60% or more by weight of the overall foamable/curable sealant composition.

The preferably high softening point or high melting point high polymeric material is a thermoplastic material, preferably a polyolefin, more preferably a homopolymer or copolymer of ethylene.

In preferred embodiments, the polymeric material comprises or essentially consists of polyethylene.

In preferred embodiments, the polyethylene has a melt flow rate (MFR), determined according to ISO 1133 at 190° C., 2.16 kg of at least 5 g/10 min, preferably at least 10 g/10 min, more preferably at least 20 g/10 min, still more preferably at least 30 g/10 min, yet more preferably at least 40 g/10 min, even more preferably at least 50 g/10 min, most preferably at least 60 g/10 min, and in particular at least 70 g/10 min.

In preferred embodiments, the polyethylene has a melt flow rate (MFR), determined according to ISO 1133 at 190° C., 2.16 kg of at most 70 g/10 min, preferably at most 60 g/10 min, more preferably at most 50 g/10 min, still more preferably at most 40 g/10 min, yet more preferably at most 30 g/10 min, even more preferably at most 20 g/10 min, most preferably at most 10 g/10 min, and in particular at most 5 g/10 min.

By way of one non-limiting example, the preferably high softening point or high melting point high polymeric material is a high density polyethylene (HDPE) resin.

By way of one non-limiting example, the preferably high softening point or high melting point high polymeric material is a low density polyethylene (LDPE) resin.

By way of another non-limiting example, the preferably high softening point or high melting point high polymeric material is a linear low density polyethylene (LLDPE) resin.

By way of another non-limiting example, the preferably high softening point or high melting point high polymeric material is an ethylene copolymer with a low percentage of comonomer.

In preferred embodiments, the polymeric material comprises or essentially consists of a copolymer, preferably ethylene vinyl acetate copolymer.

In preferred embodiments, the copolymer, preferably ethylene vinyl acetate copolymer comprises at least about 1.0% by weight, preferably at least about 2.0% by weight, more preferably at least about 3.0% by weight, still more preferably at least about 4.0% by weight of the overall polymeric material.

In preferred embodiments, the copolymer, preferably ethylene vinyl acetate copolymer comprises at least about 1.0% by weight, preferably at least about 2.0% by weight, more preferably at least about 3.0% by weight, still more preferably at least about 4.0% by weight of the overall volume expandable sealant composition.

The use of other polymeric materials is anticipated, as mentioned above.

The one or more polymeric materials included in the foamable/curable sealant composition may be produced from a variety of feed stocks. The one or more polymeric materials included in the foamable/curable sealant composition may be from recycled sources. For example, grades of post-consumer sources of polyethylene terephthalate are readily available from the recycling of water and carbonated beverage bottles. Grades of high density polyethylenes (HDPE) are readily available recycled milk containers. Grades of low density polyethylenes (LDPE) and linear low density polyethylenes (LLDPE) are readily available from many types of recycled films, including plastic grocery bags and injection molded jar lids. Illustrative examples of foamable/curable sealant compositions containing recycled grades of low density polyethylenes (LDPE) and linear low density polyethylenes (LLDPE) are shown in Table 6, Examples I-18 and I-19.

The foamable/curable sealant composition may include one or more foaming agents. The one or more foaming agents may function to produce inert gases that form, as desired, an open and/or closed cellular structure within the foamable/curable sealant composition. The foamable/curable sealant composition may contain a physical or chemical foaming agents.

Physical foaming agents may consist of a low boiling point solvent encapsulated in a polymeric shell where, upon heating, the polymeric shell softens and the low boiling point solvent boils to expand the polymeric shell causing an increase in volume and a lowering in density. One exemplary physical foaming agent suitable for use herein is available under the tradename EXPANCEL, commercially available from Nouryon, Inc.

Chemical foaming agents decompose upon exposure to heat to release gases that cause a change in volume and a reduction in density of the polymeric composition in which they are incorporated. The chemical foaming agents included in the foamable/curable sealant composition may be endothermic or exothermic.

Endothermic foaming agents may absorb heat from the matrix during activation. Suitable endothermic foaming agents include, but are not limited to, metal salts of the carbonate and bicarbonate ion. Two exemplarily endothermic foaming agents suitable for use herein are tradename KYCEROL, commercially available from Rit-Chem, and HYDROCEROL, commercially available from Clariant.

Exothermic foaming agents may release heat during activation. Suitable exothermic foaming agents include, but are not limited to, azodicarbonamides, dinitrosopentamethylenetetramine, p-toluene sulfonyl hydrazide, or p,p′-oxybis(benezensulfonylhydrazide). Preferably, azodicarbonamide is utilized as the exothermic foaming agent.

The one or more foaming agents may be present in an amount of from 0.5% or less to about 11% or more of the total weight of the foamable/curable sealant composition. The precise amount of the one or more foaming agents may be selected based on the desired amount of volume change for the particular sealant application and the temperature of the activation that is desired. By way of one non-limiting example, a composition based on a low density polyethylene (LDPE) containing 2% azodicarbonamide may provide an increase in volume of about 200 to 300% when heated in the temperature range of about 325-400° F. for about 20 to 40 minutes. Materials with this level of volume increase are preferred for applications such as water sealing, and when some level of mechanical strength may be desired. Polyethylene-based compositions made according to the present teachings, and in the range of about 200 to 400% expansion are suitable for sealing when some level of exposure to hydrocarbon-based fuels such as diesel fuel or gasoline is anticipated. Similarly, a low density polyethylene (LDPE) based sealant composition incorporating 4.2% azodicarbonamide foaming agent may provide a volume increase of 1000-1200% when heated in the temperature range of about 325-400° F. for about 20 to 40 minutes. Incorporation of azodicarbonamide at a level of 8.4% produces an increase in volume of as much as 2000% as shown in illustrative Examples I-12 and I-13 of Table 3.

The foamable/curable sealant composition may include one or more foaming agent activators. The one or more foaming agent activators may function to lower the temperature at which the foaming agents produce gas to foam the composition. Because the one or more foaming agent activators lower the foaming temperature of the foamable/curable sealant composition, their use makes it necessary to further lower the compounding temperature before adding the foaming agent and accompanying foaming agent activator or activators. The one or more foaming agent activators may include zinc or calcium salts, and/or nitrogen containing compounds. Preferably, the foaming agent activator is a metal salt, or is an oxide, e.g., a metal oxide, such as zinc oxide. Other preferred foaming agent activators include urea and substituted ureas, or the like. Dicyandiamide may also be used as a foaming agent activator.

The foamable/curable sealant composition may include one or more ingredients that function to lower either the melting temperature or softening point, lower the viscosity or lower both the melting temperature or softening point and viscosity of the foamable/curable sealant material. The one or more ingredients, herein defined as temperature processing aids, for lowering the melting temperature, softening point and/or viscosity are preferably completely compatible or at least partially compatible with the other polymeric ingredients of the foamable/curable sealant composition in the solid phase, molten phase or both. The one or more temperature processing aids are preferably added to the foamable/curable sealant composition in the early stages of processing to reduce the temperatures and shear heating generated in subsequent processing stages where heat sensitive ingredients may be added. The one or more temperature processing aids include but are not limited to hydrocarbon resins, process oils, liquid elastomers, waxes or low molecular weight polymers and copolymers. The total of the one or more temperature processing aids is preferably present at an amount of about 10% or more, more preferably 20% or more and even more preferably 30% or more. The total of the one or more temperature processing aids is preferably present at an amount of about 50% or less. The one or more temperature processing aids may include hydrocarbon resins, waxes, liquid elastomers, and low molecular weight polymers.

The one or more temperature processing aids may include one or more hydrocarbon resins. The one or more hydrocarbon resins may function to lower the melting temperature or the softening point of the foamable/curable sealant composition. The one or more hydrocarbon resins may function to lower the melt viscosity of the foamable/curable sealant composition. The one or more hydrocarbon resins may function to improve the adhesion of the foamable/curable sealant composition to a substrate (e.g., a metal). Additionally, the one or more hydrocarbon resins may function to improve overall corrosion resistance. The hydrocarbon resin may be present in an amount from about 5% or less to about 15% or more of the total weight of the foamable/curable sealant composition. Suitable hydrocarbon resins may include but are not limited to aromatic C-9 resins, aliphatic C-5 resins, and/or combinations thereof as shown in illustrative Table 1 and Table 2 presented herein. Suitable hydrocarbon resins may also include coumarone-indene resins and those based on farnesene. Suitable hydrocarbon resins may also include rosin acids and esters from bio sources.

In preferred embodiments, the one or more hydrocarbon resins comprises at least about 1.0% by weight, preferably at least about 2.0% by weight, more preferably at least about 3.0% by weight, still more preferably at least about 4.0% by weight of the overall volume expandable sealant composition.

In preferred embodiments, the one or more hydrocarbon resins comprises at most about 10% by weight, preferably at most about 9.0% by weight, more preferably at most about 8.0% by weight, still more preferably at most about 7.0% by weight of the overall volume expandable sealant composition.

It is also contemplated that the foamable/curable sealant composition lacks one or more hydrocarbon resins. As can be seen in Table 2, Comparative Example C2 (which is prepared without inclusion of any hydrocarbon resins), the expansion results indicate that the inclusion of hydrocarbon resins from the foamable/curable sealant composition are not essential for obtaining good expansion properties. As such, it is contemplated that compositions without hydrocarbon resins will be suitable in various applications known to a skilled artisan. However, for ease of processing and to obtain one or more of the improvements listed herein, such as improved adhesion to metals and/or improved corrosion resistance, incorporation of an appropriate amount of one or more hydrocarbon resins may prove beneficial.

The foamable/curable sealant composition may include a process oil. The process oil may function to lower the melting or softening point of the base polymer. The process oil may function to lower the viscosity of the foamable/curable sealant composition. Additionally, the process oil may function to lower the overall cost of the foamable/curable sealant composition. The process oil may be present in an amount of about 5% or less to about 15% or more of the total weight of the foamable/curable sealant composition. A suitable process oil may be paraffinic oil, or any other known process oil in the art and literature suitable for use herein. It is also contemplated that the foamable/curable sealant composition lacks a process oil.

Waxes are lipophilic, hard but malleable solids of low molecular weight. These may include paraffinic waxes as well as plant-based and animal-based waxes. Liquid elastomers include but are not limited to polyisobutylene, polybutadiene (available under the trade name Indopol from INEOS), isoprene rubber, styrene butadiene rubber, ethylene propylene rubber (EPR) and ethylene propylene diene monomer (EPDM) rubber (available under the trade name Trilene from Lion Elastomers). Low molecular copolymers suitable for lowering the melting point and/or the viscosity include but are not limited to polyolefin elastomer and plastomers (for example ethylene octene copolymers available under the trade name Affinity GA series available from Dow with melt index between 500-1500 g/10 min 2.16 Kg. (190° C.). Also suitable are ethylene methacrylate, ethylene butyl acrylate and ethylene vinyl acetate copolymers, particularly those with a higher melt flow rate and/or a lower melting point than the polymer that it is modifying.

The foamable/curable sealant composition may include one or more coagents. The one or more coagents may function to improve the crosslinking of the foamable/curable sealant composition. The one or more coagents may function to improve the trapping of gas. Typically, the coagent may be a low molecular weight monomeric or oligomeric material with reactive double bonds that react by a free radial mechanism. The one or more coagents may be maleimide-based or contain allylic, vinyl, acrylate, or methacrylate functionality. A common element pertaining to the coagent(s) is the presence of free radical curable double bonds that function to react with a free radical generator and the polymeric materials of the foamable/curable sealant composition. The one or more coagents may be monofunctional, difunctional, or multifunctional, indicating the number of double bonds on each molecule of coagent. Suitable coagents may include, but are not limited to, phenyl methane maleimide formaldehyde condensate, aliphatic bismaleimide, aromatic bismaleimide, ethoxylated bisphenol A diacrylate, trimethylol propane trimethacrylate, dipentaerythritol pentaacrylate, hexaacrylate blends, and/or combinations thereof and the like. Preferred coagents are those based on maleimide functionality due to their ability to perform well at very low concentrations, i.e., as low as 0.2% by weight of the total formulation. It is contemplated that the foamable/curable sealant composition may lack one or more coagents. However, the illustrative examples of Table 1 show the beneficial effect of increased expansion at all bake conditions, and particularly at a higher bake of 400° F. relative to Comparative Example C-1 that does not include a coagent.

The foamable/curable sealant composition may include one or more free-radical generators. Preferred are free-radical generators where the free generation of free radicals is initiated or accelerated by an external stimulus such as heat or ultraviolet radiation. In a preferred embodiment the generation of free radicals is accelerated by heat. Free radical generators include but are not limited to persulfates, azo compounds, and hydroperoxides. In a preferred embodiment the free radical generator is an organic peroxide. The one or more free-radical generators may function to generate free radicals in sufficient quantity to affect crosslinking of the foamable/curable sealant composition by interacting with the one or more coagents and one or more polymeric materials contained in the composition. The one or more free-radical generators used during the final stage of compounding may have a long half-life at ambient and moderately elevated temperatures. The one or more organic peroxides may exhibit a shorter half-life near or above the temperature at which the composition is formulated to generate gas. The one or more free-radical generators may be present in an amount of from about 0.5% or less to about 1.5% or more of the total weight of the foamable/curable sealant composition. Suitable free-radical generators of the organic peroxide type include, but are not limited to, butyl 4,4-di(tert-butylperoxy)-valerate, and 1,1-Di(tert-butylperoxy)-3,3,5-trimethylcyclohexane, or any other known organic peroxides in the art and literature suitable for use herein.

Comparative Example C-3, shown in Table 2, is compounded without the use of any organic peroxides. While expansion at lower bake conditions is similar to the expansion containing the organic peroxide, the composition has improved flow, as the vertical rise of the composition is lower. More significantly, the volumetric expansion at higher temperatures of about 400° F. is significantly reduced without the addition of organic peroxides. Thus, to achieve increased volumetric expansion at high bake temperatures, the addition of organic peroxides proves beneficial.

The foamable/curable sealant composition may include an antioxidant. The antioxidant may function to prevent degradation of the polymeric materials during compounding and/or to scavenge any free radicals that may be generated during the compounding of the foamable/curable sealant composition. The antioxidant may already be incorporated into the polymeric material(s) of the foamable/curable sealant composition by the manufacturer or may be separately added into the foamable/curable sealant composition. Suitable antioxidants may be any suitable antioxidant known in the art and literature. Levels of antioxidants suitable for use herein may be that which is present and added to the polymeric material by the manufacturer. It is also contemplated that the foamable/curable sealant composition lacks antioxidants.

The foamable/curable sealant composition may include one or more pigments. The one or more pigments may be useful in marking the foamable/curable sealant composition for identification and/or for detection of the sealant to confirm proper installation of the seal during an assembly operation. Suitable pigments may include, but are not limited to, various organic and inorganic pigments, metal oxides, carbon black and the like.

The foamable/curable sealant composition may include one or more inert fillers. The one or more inert fillers may function to reinforce the cell walls for improved foaming characteristics. The one or more inert fillers may function to modify the rheology of the foamable/curable sealant composition, particularly as the composition is being heated, to reduce sagging or sliding of the sealant before or during cure. Additionally, the inert filler may function to reduce the overall cost of the foamable/curable sealant composition. Suitable inert fillers may include, but are not limited to, calcium carbonate, talc, wollastonite, various types of clay, metal oxides, silica, mica, and the like. The one or more inert fillers may also include materials in the form of fiber, such as glass fibers, aramid fibers, cellulosic fibers, polymeric fibers, and the like. The one or more inert fillers may be present as round or substantially round particles, and/or as flakes, needles, and platelets. It is also contemplated that the foamable/curable sealant composition lacks an inert filler.

### Formation

Formation of the foamable/curable sealant composition may be achieved by a multi-stage or multi-step processing method. In a first compounding step or steps, polymeric material(s) are compounded with modifying ingredients. The polymeric materials, as described herein above, may exhibit high melting or softening points. The modifying ingredients may function to lower the melting or softening point, lower the viscosity, or lower both the melting or softening point and the viscosity of the polymeric material(s). The modifying ingredients may be selected from lower melting point polymeric materials, lower softening point polymeric materials, lower molecular weight polymeric materials, waxes, hydrocarbon resins, plasticizers, process oils, and the like or combinations thereof, as described herein. Preferably, the modifying ingredients are added at a level less than that of the higher melting or softening point polymeric material(s). Preferably, the modifying ingredients are at least partially compatible with the higher melting point or softening point polymeric material(s). It is contemplated that the compounding of the higher melting point or higher softening point polymeric materials with the modifying ingredients may be carried out in one or more initial first steps, as necessary to achieve the desired resulting first mixture. The resulting first mixture may comprise a mixture with lower melting or softening point, a lower viscosity, or both. Importantly, the ingredients that play a role in the activation of the foamable/curable sealant composition are excluded from these first compounding step or steps.

For safe compounding (i.e., to avoid unwanted activation during the process of forming a part) it may be necessary to maintain the compounding temperature well below the temperature at which the foamable/curable sealant composition will activate. For effective mixing, it may be necessary to compound a polymeric material at a temperature above its softening or melting point. For example, for a crystalline polymeric material, it is preferable that the compounding temperature is at least 10° C. above the melt temperature of the material. For amorphous polymeric materials without a distinct melt temperature, it may be necessary to compound the material at least 10° C. above its softening point. Preferably, compounding may occur at least 20° C. above a material's softening point. For materials in accordance with the teachings herein that foam and/or cure at about 150° C. or less, it may be necessary to compound such materials at about 120° C. or less, or preferably at about 110° C. or less, or more preferably at 105° C. or less. As such, this would likely limit usable polymeric materials to those with melting or softening points below 100° C., when using a single step or single stage process. Some exemplary polymeric materials of this type include, but are not limited to, copolymers of ethylene monomers such as vinyl acetate, methyl acrylate, ethyl acrylate, and butyl acrylate at levels of 18% or more comonomer. Such materials are effective at the disruption of polymer chain regularity and therefore its crystallization ability. Additionally, suitable exemplary elastomeric materials with no discernable melting or softening point include, but are not limited to, ethylene propylene diene monomer rubber (EPDM), styrene-butadiene rubber (SBR), nitrile butadiene rubber (NBR), and bromobutyl rubber.

In a second or later compounding step, the resulting mixture is compounded with one or more foamable/curable ingredients. The foamable/curable ingredients may be selected from foaming agents, foaming agent activators, coagents and the like or combinations thereof, as described herein. This second or later compounding step occurs at a lower temperature than the first compounding step or steps and is typically, or preferably, of shorter duration than the first compounding step or steps. Importantly, this second or later compounding step is not performed until the processing temperature of the mixture has been reduced, so as to not activate the heat sensitive components.

Optionally, a masterbatch may be created during the multi-step processing method. When a portion of the final product is compounded and collected for further processing, the material is typically referred to as a masterbatch. However, it is not essential to create and isolate a masterbatch. For example, where both the first compounding step or steps and the second or later compounding step are performed using a batch mixing process, it is not necessary for the resulting mixture of the first compounding step or steps be discharged from the mixer or cooled to ambient temperature. Instead, sufficient heat energy would need to be removed from the first resulting mixture such that activation of the reactive ingredients added during the second or later compounding step does not occur.

The illustrative examples in Table 5 are prepared without the use of a masterbatch, demonstrating that the foamable/curable sealant composition of the present teachings can be prepared instead according to a carefully staged addition of ingredients. Whether a formation of a distinct masterbatch is created or not, it is important that the temperature of the compounded ingredients be brought to a sufficiently low temperature as to not activate foaming or crosslinking agents used to produce the final foamable composition.

### Mixing and Shaping

The multi-step processing method presented herein may employ various types of mixing techniques. It is contemplated that any suitable mixing technique known in the art and literature may be utilized to prepare the foamable/curable sealant composition provided that the first compounding step or steps produces a mixture suitable for use in the second or later compounding step. For example, batch compounding methods, continuous compounding methods, or a combination thereof may be employed. Batch mixing equipment suitable for use herein includes, but is not limited to, double arm sigma blade mixers, Banbury mixers, Shaw mixers, planetary mixers, and the like. Continuous processing equipment suitable for use herein includes, but is not limited to, co-rotating or counter-rotating twins screw extruders, buss kneaders, single screw extruders with mixing elements, and the like.

In a more conventional, one-step, batch compounding process, all ingredients that require melt processing would need to be melt processible at a temperature below the activation temperature of the heat reactive components. Melt processing of crystalline materials must be done at a temperature at least slightly above their melting point (for example 10° C. above). Melt processing of amorphous materials must be done at a temperature at least slightly above their softening point. Melt processible ingredients would include thermoplastic polymers, rubbers or elastomers, solid hydrocarbon resins, solid epoxy resins and the like. In a one-step compounding process, the minimum processing temperature is determined by the ingredient with highest melting point or softening point. To avoid any chance of activation of the heat activate components the maximum processing temperature would be at least 10° C. below, more preferably 20° C. below and more preferably 30° C. below the activation temperature of the heat activated components (for example blowing agent and latent peroxides).

The foamable/curable sealant composition/material formed by the multi-step processing method may be shaped according to various techniques known in the art and literature. For example, the foamable/curable sealant material may be pre-formed. Pre-formed is defined herein as being supplied with a distinct shape and stable dimensions prior to activation. The material may be supplied as sheets, strips, patches, rings, discs, and the like. In one embodiment, the foamable/curable sealant material may be injection molded. In another embodiment, the foamable/curable sealant material may be extruded (e.g., in sheets) or through a profile die that produces a continuous stream of material with a complex geometric shape. The material may then be cut into sections of a desired length, to create a part with three-dimensional shape. The material may be supplied alone, or in combination with other components, such as metals, composites, thermosets, or thermoplastics. In a preferred embodiment, the material is supplied on a molded polyamide or polyester to form a sealing baffle.

The term baffle herein is defined to mean a structure designed to form a barrier to the movement of air, moisture, dust, noise, combinations thereof and the like. In a typical design, an inert component consisting of a thermoplastic, thermoset, metal, composite material, or the like is combined with an foamable/curable material that foams and adheres to a variety of surfaces. The foamable/curable material may be disposed around the perimeter of the inert material. The baffle may contain pins or tabs for positioning of the baffle and for holding the baffle in place prior to activation of the foamable/curable material. When inserted into a cavity, for example an A-pillar, B-pillar or C-pillar of an automobile, there is a space between the baffle and the walls of the cavity that the baffle is meant to seal, allowing the various cleaning, phosphating, and e-coating solutions to drain from the vehicle. However, upon activation, the sealant material disposed around the perimeter of the baffle foams until it touches the walls of the cavity and adheres to the walls of the cavity, thus sealing the cavity and holding the baffle firmly in place.

### EXAMPLES

The present teachings may be further explained by the following non-limiting examples, presented in tabular form. The ingredients used in the illustrative examples and comparative controls are listed in Table 7, below. Additionally, Table 6 presented herein below shows the Masterbatch compositions used in the illustrative examples.

Table 1 shows Illustrative Examples I-1 through I-7, and Comparative Control, C-1. Comparative Control C-1 was prepared without the use of a coagent.

TABLE 1
Illustrative Examples I-1 through I-7 and Comparative Control, C-1.

| | I-1 | I-2 | I-3 | I-4 | I-5 | I-6 | I-7 | C-1 |
|---|---|---|---|---|---|---|---|---|
| Example | % | % | % | % | % | % | % | % |
| Masterbatch A | 59.75 | 59.75 | 59.75 | 59.75 | 59.75 | 59.75 | 59.75 | 59.75 |
| EPDM 1 | 5.00 | 5.00 | 5.00 | 5.00 | 5.00 | 5.00 | 5.00 | 5.00 |
| HC Resin 1 | 5.25 | 5.25 | 5.25 | 5.25 | 5.25 | 5.25 | 5.25 | 5.25 |
| Coagent 1 | 0.20 | | | | | | | |
| Coagent 2 | | 0.65 | | | | | | |
| Coagent 3 | | | 0.20 | | | | | |
| Coagent 4 | | | | 1.20 | | | | |
| Coagent 5 | | | | | 1.00 | | | |
| Coagent 6 | | | | | | 0.60 | 0.30 | |
| Process Oil 1 | 5.80 | 5.80 | 5.80 | 5.80 | 5.80 | 5.80 | 5.80 | 5.80 |
| Blowing Agent 1 | 4.20 | 4.20 | 4.20 | 4.20 | 4.20 | 4.20 | 4.20 | 4.20 |
| Activator 1 | 3.00 | 3.00 | 3.00 | 3.00 | 3.00 | 3.00 | 3.00 | 3.00 |
| Activator 2 | 0.20 | 0.20 | 0.20 | 0.20 | 0.20 | 0.20 | 0.20 | 0.20 |
| Peroxide 1 | 1.50 | 1.50 | 1.50 | 1.50 | 1.50 | 1.50 | 1.50 | 1.50 |
| Peroxide 2 | 0.50 | 0.50 | 0.50 | 0.50 | 0.50 | 0.50 | 0.50 | 0.50 |
| Antioxidant | 0.50 | 0.50 | 0.50 | 0.50 | 0.50 | 0.50 | 0.50 | 0.50 |
| Pigment | 0.05 | 0.05 | 0.05 | 0.05 | 0.05 | 0.05 | 0.05 | 0.05 |
| Filler | 14.05 | 13.60 | 14.05 | 13.05 | 13.25 | 13.65 | 13.95 | 14.25 |
| | 100.00 | 100.00 | 100.00 | 100 | 100 | 100.00 | 100.00 | 100.00 |

Volumetric Expansions

| | | | | | | | | |
|---|---|---|---|---|---|---|---|---|
| 325° F./30 min | 1128% | 1113% | 1077% | 1089% | 1065% | 1043% | 1043% | 967% |
| 340° F./20 min | 1157% | 1156% | 1075% | 1115% | 1097% | 1101% | 1090% | 996% |
| 400° F./40 min | 1236% | 1233% | 1000% | 1178% | 1162% | 1143% | 1160% | 634% |

Table 2 shows Illustrative Examples I-8 through I-11 and Comparative Example C2 and C3. Comparative Example C2 is prepared without the use of a hydrocarbon resin. Comparative Example C3 is prepared without the use of an organic peroxide.

TABLE 2
Illustrative Examples I-8 through I-11
and Comparative Example C2 and C3.

| | I-8 | I-9 | I-10 | I-11 | C-2 | C-3 |
|---|---|---|---|---|---|---|
| Example | % | % | % | % | % | % |
| Masterbatch A | | | | | | 59.75 |
| Masterbatch B | 59.75 | 59.75 | | | | |
| Masterbatch C | | | 59.75 | 59.75 | | |
| Polymer PE 1 | | | | | 53.53 | |
| Copolymer 1 | | | | | 5.88 | |
| EPDM 1 | 5.00 | 5.00 | 5.00 | 5.00 | 10.59 | 5.00 |
| HC Resin 1 | | | | | | 5.25 |
| HC Resin 2 | 5.25 | 5.25 | | | | |
| HC Resin 3 | | | 5.25 | 5.25 | | |
| Coagent 1 | 0.20 | | 0.20 | | | 0.20 |
| Coagent 6 | | 0.60 | | 0.60 | 0.60 | |
| Process Oil | 5.80 | 5.80 | 5.80 | 5.80 | 5.80 | 5.80 |
| Blowing | 4.20 | 4.20 | 4.20 | 4.20 | 4.20 | 4.20 |
| Agent 1 | | | | | | |
| Activator 1 | 3.00 | 3.00 | 3.00 | 3.00 | 3.00 | 3.00 |
| Activator 2 | 0.20 | 0.20 | 0.20 | 0.20 | 0.20 | 0.20 |
| Peroxide 1 | 1.50 | 1.50 | 1.50 | 1.50 | 1.50 | |
| Peroxide 2 | 0.50 | 0.50 | 0.50 | 0.50 | 0.50 | |
| Antioxidant | 0.50 | 0.50 | 0.50 | 0.50 | 0.50 | 0.50 |
| Pigment | 0.05 | 0.05 | 0.05 | 0.05 | 0.05 | 0.05 |
| Filler | 14.05 | 13.65 | 14.05 | 13.65 | 13.65 | 16.05 |
| | 100.00 | 100.00 | 100.00 | 100.00 | 100.00 | 100.00 |

Volumetric Expansions

| | | | | | | |
|---|---|---|---|---|---|---|
| 325° F./30 min | 1104% | 1071% | 1093% | 1084% | 1037% | 997% |
| 340° F./20 min | 1132% | 1125% | 1145% | 1134% | 1054% | 1016% |
| 400° F./40 min | 1056% | 1135% | 1000% | 932% | 976% | 191% |

Table 3 shows the higher volumetric expansion of Illustrative Examples I-12 and I-13.

TABLE 3
Illustrative Examples I-12 and I-13

| | I-12 | I-13 |
|---|---|---|
| Example | % | % |
| Masterbatch A | 59.75 | 59.75 |
| EPDM 1 | 5.00 | 5.00 |
| HC Resin 1 | 5.25 | 5.25 |
| Coagent 1 | 0.20 | |
| Coagent 6 | | 0.60 |
| Process Oil | 5.80 | 5.80 |
| Blowing Agent 1 | 8.40 | 8.40 |
| Activator 1 | 3.00 | 3.00 |
| Activator 2 | 0.20 | 0.20 |
| Peroxide 1 | 0.50 | 0.50 |
| Peroxide 2 | 1.50 | 1.50 |
| Antioxidant | 0.50 | 0.50 |
| Pigment | 0.05 | 0.05 |
| Filler | 9.9 | 9.45 |
| | 100.00 | 100.00 |

Volumetric Expansions

| | | |
|---|---|---|
| 325° F. (163° C.)/30 min | 1967% | 1860% |
| 340° F. (171° C.)/20 min | 2016% | 1926% |
| 400° F. (204 C°)/40 min | 2112% | 1934% |

Table 4 shows Illustrative Examples I-14 to I-17.

TABLE 4
Illustrative Examples I-14 to I-17

| | I-14 | I-15 | I-16 | I-17 |
|---|---|---|---|---|
| Example | % | % | % | % |
| Polymer PE2 | | 45.50 | | |
| Polymer PE3 | | | | 45.50 |
| Polymer PE4 | | | 45.50 | |
| Polymer PE5 | 45.50 | | | |
| Copolymer 1 | | 4.50 | | |
| Copolymer 2 | 9.00 | 4.50 | 9.00 | 9.00 |
| EPDM 1 | 5.00 | 5.00 | 5.00 | 5.00 |
| HC Resin 1 | 10.50 | 10.50 | 10.50 | 10.50 |
| Coagent 1 | 0.20 | 0.20 | 0.20 | 0.20 |
| Process Oil | 5.80 | 5.80 | 5.80 | 5.80 |
| Blowing Agent 1 | 4.20 | 4.20 | 4.20 | 4.20 |
| Activator 1 | 3.00 | 3.00 | 3.00 | 3.00 |
| Activator 2 | 0.20 | 0.20 | 0.20 | 0.20 |
| Peroxide 1 | 0.50 | 0.50 | 0.50 | 0.50 |
| Peroxide 2 | 1.50 | 1.50 | 1.50 | 1.50 |
| Antioxidant | 0.50 | 0.50 | 0.50 | 0.50 |
| Pigment | 0.05 | 0.05 | 0.05 | 0.05 |
| Filler | 14.05 | 14.05 | 14.05 | 14.05 |
| | 100.00 | 100.00 | 100.00 | 100.00 |

Volumetric Expansions

| | | | | |
|---|---|---|---|---|
| 325° F. (163°° C.)/30 min | 1071% | 1072% | 1022% | 1027% |
| 340° F. (171° C.)/20 min | 1098% | 1100% | 1073% | 1059% |
| 400° F. (204 C°)/40 min | 1108% | 1166% | 1104% | 1107% |

Table 5 shows the use of recycle polyethylene in Illustrative Examples 1-18 and I-19. The ingredients used in the illustrative examples are listed in Table 7, below.

TABLE 5
Inventive Examples I-18 and I-19

| | I-18 | I-19 |
|---|---|---|
| Examples | % | % |
| Masterbatch D | 51.30 | |
| Masterbatch E | | 59.50 |
| Copolymer 1 | 9.00 | |
| EPDM 1 | 5.00 | |
| HC Resin 1 | 10.50 | 10.50 |
| Coagent 1 | 0.20 | 0.20 |
| Process Oil | | 5.80 |
| Blowing Agent 1 | 4.20 | 4.20 |
| Activator 1 | 3.00 | 3.00 |
| Activator 2 | 0.20 | 0.20 |
| Peroxide 1 | 0.50 | 0.50 |
| Peroxide 2 | 1.50 | 1.50 |
| Antioxidant | | 0.50 |
| Pigment | 0.05 | 0.05 |
| Filler | 14.55 | 14.05 |
| | 100.00 | 100.00 |

Volumetric Expansions

| | | |
|---|---|---|
| 325° F. (163°° C.)/30 min | 911% | 1071% |
| 340° F. (171° C.)/20 min | 932% | 1080% |
| 400° F. (204 C°)/40 min | 886% | 1043% |

Table 6 shows the Masterbatch Compositions A-E used in the Illustrative Examples.

TABLE 6

| | A | B | C | D | E |
|---|---|---|---|---|---|
| Masterbatch | % | % | % | % | % |
| Polymer PE1 | 76.15 | 76.15 | 76.15 | | |
| Copolymer 1 | 15.06 | 15.06 | 15.06 | | |
| Polymer RePE 1 | | | | 69.60 | 78.70 |
| Polymer RePE 2 | | | | | |
| HC Resin 1 | 8.79 | | | | |
| HC Resin 2 | | 8.79 | | | |
| HC Resin 3 | | | 8.79 | | |
| EPDM 2 | | | | | 21.30 |
| Process Oil | | | | 30.00 | |
| Antioxidant | | | | 0.50 | |
| Total | 100.00 | 100.00 | 100.00 | 100.00 | 100.00 |

Table 7 lists the ingredients used in the Illustrative and Comparative Examples.

TABLE 7

| Ingredient | Description |
|---|---|
| Polymer PE1 | Low density polyethylene (LDPE) with MFR of 70 g/10 min (190° C., 2.16 kg) and |
| | density of 0.920 g/cm³ |
| Polymer PE2 | Low density polyethylene (LDPE) with MFR of 35 g/10 min (190° C., 2.16 kg) and |
| | density of 0.924 g/cm³ |
| Polymer PE3 | Low density polyethylene (LDPE) with MFR of 15 g/10 min (190° C., 2.16 kg) and |
| | density of 0.915 g/cm³ |
| Polymer PE4 | Low density polyethylene (LDPE) with MFR of 7 g/10 min (190° C., 2.16 kg) and |
| | density of 0.917 g/cm³ |
| Polymer PE5 | Linear low density polyethylene (LLDPE) with MFR of 20 g/10 min (190° C., 2.16 kg) |
| | and density of 0.924 g/cm³ |
| Polymer | Recycled low density polyethylene (LDPE) with MFR of 2.5 g/10 min (190° C., 2.16 |
| RePE1 | kg) and density of 0.926 g/cm³. |
| Polymer | Recycled linear low density polyethylene (LLDPE) with MFR of 50 g/10 min (190° C., |
| RePE2 | 2.16 kg) and density of 0.926 g/cm³. |
| HC Resin 1 | C9 Hydrocarbon resin with softening point of 90° C. |
| HC Resin 2 | Mixed C5/C9 Hydrocarbon resin with softening point of 90° C. |
| HC Resin 3 | C9 Hydrocarbon resin with softening point of 105° C. |
| Process Oil 1 | Paraffinic Oil with viscosity of 113 cSt at 40° C. |
| Copolymer 1 | EVA copolymer with 18% VA content and MFR of 3 g/10 min (190° C., 2.16 kg) |
| Copolymer 2 | EVA copolymer with 18% VA content and MFR of 150 g/10 min (190° C., 2.16 kg) |
| EPDM 1 | Mooney (ML 1 + 4 at 125° C.) = 25, 58% Ethylene, 4.7% ENB |
| EPDM 2 | Mooney (ML 1 + 4 at 125° C.) = 40, 65% Ethylene, 3.1% DCPD |
| Blowing | Azodicarbonamide |
| Agent | |
| BA Activator | Zinc Oxide |
| 1 | |
| BA Activator | Dicyandiamide |
| 2 | |
| Coagent 1 | Phenyl methane maleimide formaldehyde condensate |
| Coagent 2 | Aliphatic bismaleimide |
| Coagent 3 | Aromatic bismaleimide |
| Coagent 4 | Ethoxylated bisphenol A diacrylate |
| Coagent 5 | Trimetholyl propane trimethacrylate |
| Coagent 6 | Dipentaerythritol pentaacrylate, hexaacrylate blend |
| Peroxide 1 | Butyl 4,4-di(tert-butylperoxy)valerate, 40% active |
| Peroxide 2 | 1,1-Di(tert-butylperoxy)-3,3,5-trimethylcyclohexane, 40% active |
| Pigment | Various organic and inorganic |
| Filler | 4 micron ground calcium carbonate |

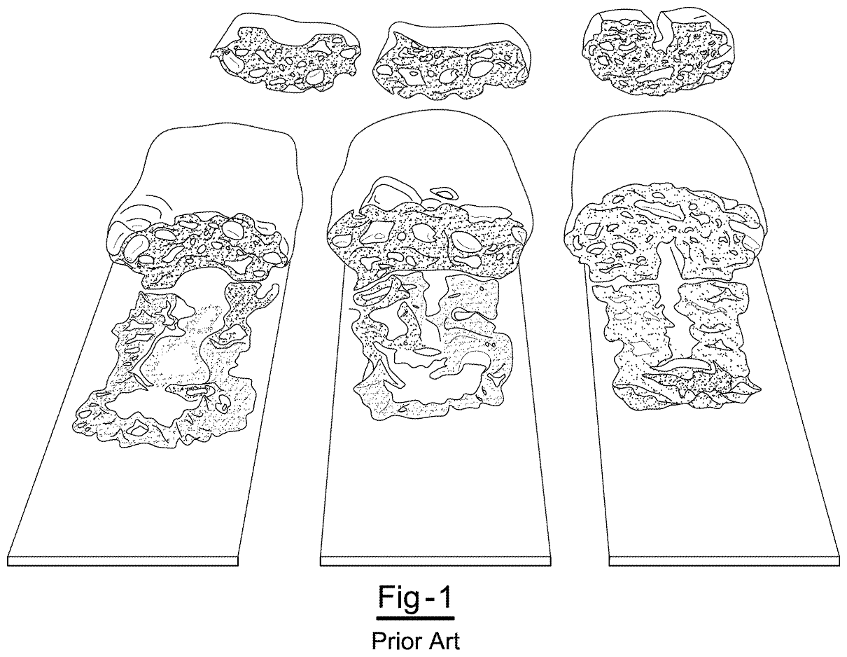

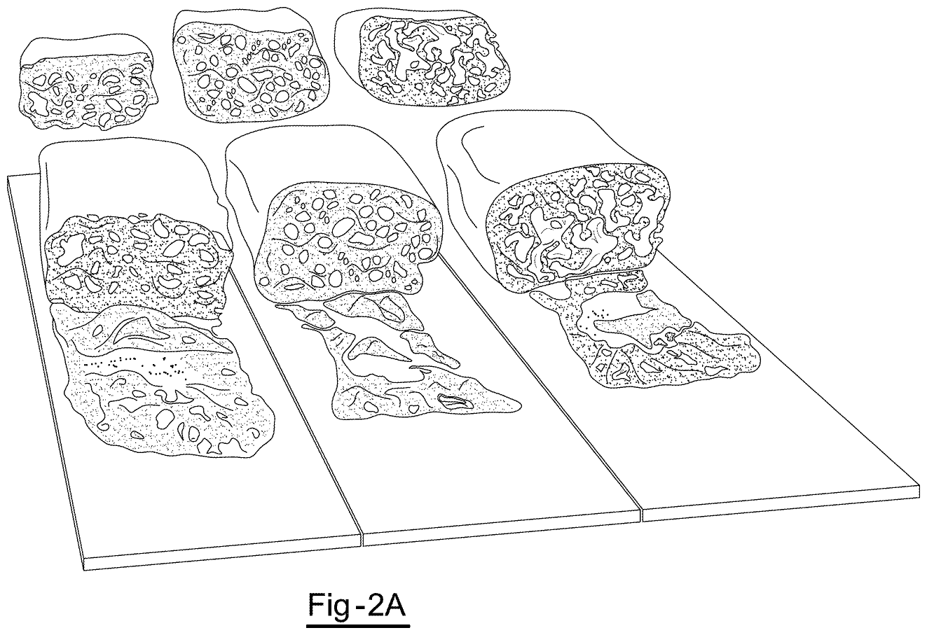

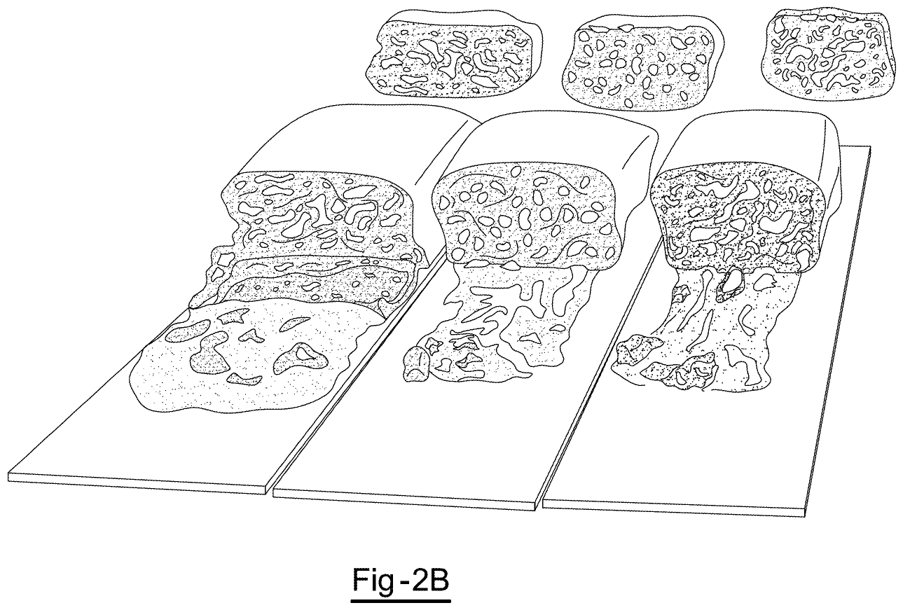

The data in Tables 8 through 10 illustrate several positive performance advantages associated with the compositions of the above inventive examples. The data in Table 8 demonstrate that compositions of the teachings herein can maintain very good foaming performance even after exposure to severe humidity at 35° C. for one week immediately prior to activation and the indicated bake condition. The materials maintain more than 85% of their volumetric expansion after this humidity exposure condition when compared to their volumetric expansion without such exposure. The improved foaming behavior after exposure to humidity is manifested particularly at the higher bake condition. It is also advantageous that the materials according to the invention have better cell structure with fewer surface defects when activated after humidity exposure when compared to a commercial sealant with similar expansion. The resulting L-2811 Commercial Sealant is shown after exposure in FIG. 1, and examples I-2 and I-5 are shown in FIGS. 2A and 2B. In each of the figures, the left side specimen was exposed to a temperature 400° F. for 40 minutes, the center specimen was exposed to a temperature of 340° F. for 20 minutes, and the right side specimen was exposed to a temperature of 325° F. for 30 minutes.

TABLE 8

| | | Bake Condition | | |
|---|---|---|---|---|
| | | 325° F. | 340° F. | 400° F. |
| Material | Exposure Condition | 30 minutes | 20 minutes | 40 minutes |
| Example 1-2 | Initial Volumetric Expansion | 1113% | 1156% | 1233% |
| Example 1-2 | After 1 Week, 35° C. condensing humidity | 993% | 1016% | 1153% |
| Example 1-5 | Initial Volumetric Expansion | 1065% | 1097% | 1162% |
| Example 1-5 | After 1 Week, 35° C. condensing humidity | 931% | 962% | 1040% |
| L-2811Commerial Sealant | Initial Volumetric Expansion | 1168% | 1184% | 1166% |
| L-2811Commerial Sealant | After 1 Week, 35° C. condensing humidity | 1052% | 1084% | 838% |

Materials according to the teachings herein also demonstrate performance advantages after activation. The data in Table 9 demonstrate that materials according to the teachings herein have lower water absorption after activation when compared to commercial materials with similar volumetric expansion levels.

TABLE 9

| | Water Absorption |
|---|---|
| | by Weight after 8 |
| Material | Hours Submersion (%): |
| Example 1-1 | 1.70 |
| Example 1-7 | 1.37 |
| Example I-19 | 2.35 |
| L-2811 Commerical Sealant | 3.45 |
| Approximately 1100% Volume Expansion | |
| Example 1-12 | 4.92 |
| Example 1-13 | 4.86 |
| L-2821 Commercial Sealant | 6.89 |
| Approximately 2000% Volume Expansion | |

Data in Table 10 demonstrate that materials according to the teachings herein can also provide improved resistance to exposure to hydrophobic fluids such as automotive fuels. The durometer of several inventive materials and a commercial control are measured after activation followed by immersion for 24 hours to Ford Fuel B, a mixture of 70% isooctane and 30% toluene by weight. Immediately after the 24-hour exposure the durometer of each material is remeasured. Materials according to the teachings herein maintain at least half of their initial durometer reading after 24 hours of immersion in Fuel B while the durometer reading of the commercial high expanding material has fallen to 0. Even the higher expanding Examples I-12 and I-13 maintain 50% or more of their initial durometer value.

TABLE 10

| | Durometer | Durometer Reading |
|---|---|---|
| | Reading Before | After 24 Hrs |
| Material | Exposure: | Exposure: |
| Example 1-1 | 39 | 26 |
| Example 1-7 | 36 | 17 |
| Example 1-12 | 24 | 14 |
| Example 1-13 | 24 | 12 |
| Example 1-14 | 44 | 32 |
| Example 1-15 | 42 | 30 |
| L-2811 Commerical Sealant | 18 | 0 |
| Approximately 1100% Volume | | |
| Expansion | | |

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/−10° or less, about +/−5° or less, or even about +/−1° or less. The terms “generally” or “substantially” to describe angular measurements may mean about +/−0.01° or greater, about +/−0.1° or greater, or even about +/−0.5° or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, from 20 to 80, or from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01, or 0.1 as appropriate. These are only examples of what is specifically intended and all possible combinations of numerical values between the lowest value and the highest value enumerated are to be considered to be expressly stated in this application in a similar manner. Unless otherwise stated, all ranges include both endpoints and all numbers between the endpoints.

As can be seen, the teaching of amounts expressed as “parts by weight” herein also contemplates the same ranges expressed in terms of percent by weight. Thus, an expression in the of a range in terms of “at least ‘x’ parts by weight of the resulting composition” also contemplates a teaching of ranges of same recited amount of “x” in percent by weight of the resulting composition.”

The term “consisting essentially of” to describe a combination shall include the elements, ingredients, components, or steps identified, and such other elements ingredients, components or steps that do not materially affect the basic and novel characteristics of the combination. The use of the terms “comprising” or “including” to describe combinations of elements, ingredients, components, or steps herein also contemplates embodiments that consist essentially of the elements, ingredients, components, or steps.

Plural elements, ingredients, components, or steps can be provided by a single integrated element, ingredient, component, or step. Alternatively, a single integrated element, ingredient, component, or step might be divided into separate plural elements, ingredients, components, or steps. The disclosure of “a” or “one” to describe an element, ingredient, component, or step is not intended to foreclose additional elements, ingredients, components, or steps.

It is understood that the above description is intended to be illustrative and not restrictive. Many embodiments as channel as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

1. A sealant composition comprising:
i. at least 50% by weight of one or more high softening point or high melting point polymeric materials;
ii. one or more foaming agents;
iii. one or more foaming agent activators; and
iv. one or more temperature processing aids.

2. The sealant composition of claim 1, wherein the one or more processing aids are selected from hydrocarbon resins, waxes, liquid elastomers, low molecular weight polymers, and combinations thereof.

3. The sealant composition of claim 1, including a coagent wherein the coagent is selected from acrylates, methacrylates, or maleimides.

4. The sealant composition of claim 1, wherein the one or more preferably high softening point or high melting point polymeric materials is selected from: high density polyethylene (HDPE), low density polyethylene (LDPE), or linear low density polyethylene (LLDPE).

5. The sealant composition of claim 1, wherein the one or more preferably high softening point or high melting point polymeric materials is recycled from post-industrial or post-consumer sources.

6. (canceled)

7. The sealant composition of claim 1, wherein the one or more foaming agents is azodicarbonamide.

8. The sealant composition of claim 7, wherein the one or more foaming agent activators is selected from: zinc oxide, dicyandiamide, calcium salts, ureas, or substituted ureas.

9-11. (canceled)

12. The sealant composition of claim 4, wherein the composition is heat-activated.

13. The sealant composition of claim 1, wherein the composition is supplied as a sheet, a strip, a patch, a ring, a disc, or combinations thereof to an article of manufacture.

14. The sealant composition of claim 13, wherein the article of manufacture is a sealing baffle for an automotive vehicle.

15. An article of manufacture comprising a volume expandable sealant composition comprising:
(i) a polymeric material comprising or essentially consisting of a polyolefin;
preferably a polyethylene;
more preferably a polyethylene selected from the group consisting of high density polyethylene (HDPE), low density polyethylene (LDPE), linear low density polyethylene (LLDPE), and combinations thereof;
(ii) one or more foaming agents;
(iii) one or more foaming agent activators; and
(iv) one or more temperature processing aids.

16. The article of manufacture according to claim 15, wherein the polymeric material comprises or essentially consists of polyethylene.

17. The article of manufacture according to claim 16, wherein the polyethylene has a melt flow rate (MFR), determined according to ISO 1133 at 190° C., 2.16 kg of at least 5 g/10 min, preferably at least 10 g/10 min, more preferably at least 20 g/10 min, still more preferably at least 30 g/10 min, yet more preferably at least 40 g/10 min, even more preferably at least 50 g/10 min, most preferably at least 60 g/10 min, and in particular at least 70 g/10 min.

18. The article of manufacture according to claim 16, wherein the polyethylene has a melt flow rate (MFR), determined according to ISO 1133 at 190° C., 2.16 kg of at most 70 g/10 min, preferably at most 60 g/10 min, more preferably at most 50 g/10 min, still more preferably at most 40 g/10 min, yet more preferably at most 30 g/10 min, even more preferably at most 20 g/10 min, most preferably at most 10 g/10 min, and in particular at most 5 g/10 min.

19. The article of manufacture according to claim 16, wherein the polyethylene comprises or essentially consists of high density polyethylene (HDPE).

20. The article of manufacture according to claim 16, wherein the polyethylene comprises or essentially consists of low density polyethylene (LDPE).

21. (canceled)

22. The article of manufacture according to claim 16, wherein the polyethylene comprises at least about 30% by weight, preferably at least about 40% by weight, more preferably at least about 50% by weight, still more preferably at least about 60% by weight of the overall polymeric material.

23. The article of manufacture according to claim 16, wherein the polyethylene comprises at least about 30% by weight, preferably at least about 40% by weight, more preferably at least about 50% by weight, still more preferably at least about 60% by weight of the overall volume expandable sealant composition.

24-34. (canceled)

35. The article of manufacture according to claim 16, including a coagent selected from acrylates, methacrylates, or maleimides; preferably selected from phenyl methane maleimide formaldehyde condensate, aliphatic bismaleimide, aromatic bismaleimide, ethoxylated bisphenol A diacrylate, trimethylol propane trimethacrylate, and dipentaerythritol pentaacrylate, hexaacrylate blend.

36-51. (canceled)

52. A sealant composition comprising:
v. one or more preferably high softening point or high melting point polymeric materials;
vi. one or more foaming agents;
vii. one or more foaming agent activators; and
viii. one or more ingredients selected from the following: hydrocarbon resins, process oils, waxes, EPDM, liquid elastomers, high melt flow copolymers or low melting point copolymers.
